(19) United States
(12) Patent Application Publication
(10) Pub. No.: US 2021/0325557 A1
(43) Pub. Date: Oct. 21, 2021

(54) SOURCE ARRAY CONFIGURATION FOR REPEATED MARINE SEISMIC SURVEYING OF THE SAME AREA

(71) Applicants: Erik GODØY, Nesbru (NO); POLARCUS DMCC, Dubai (AE)

(72) Inventor: Phillip M. FONTANA, DUBAI (AE)

(21) Appl. No.: 16/468,364

(22) PCT Filed: Jan. 30, 2018
(86) PCT No.: PCT/NO2018/050026

§ 371 Date: Jun. 11, 2019

(30) Foreign Application Priority Data
Feb. 1, 2017 (NO) 20170155

(51) Int. Cl. G01V 1/38

(52) U.S. Cl. CPC G01V 1/3861; G01V 1/3852; G01V 1/3835

(57) ABSTRACT

A method for conducting a seismic survey for collecting seismic data off shore. It comprises a first seismic survey providing a first set of data for an area using individual seismic sub-source arrays (2). It further comprises a second seismic survey of the same area for providing a second set of data. The individual seismic sub-source arrays (2) are similar to the sub-source arrays used during the former survey and are arranged in more than two shot-unit sources (3). Each shot-unit source (3) comprises a pair of neighboring individual seismic sub-source arrays (2) arranged to be fired substantially at the same time.

The present invention relates to a method for conducting a seismic survey for collecting seismic data off shore comprising:

towing a seismic source array comprising individual seismic sub-source arrays,

towing the seismic source array behind a marine vessel in a towing direction generating desired acoustic signals by activating the seismic source array by releasing acoustic shots means,

and said acoustics signals are reflected when hitting a seabed, said reflected signals are picked up by streamer cables each carrying a plurality of receivers, and said reflected acoustic signals are transferred into seismic pictures,

the method further comprises a first seismic survey of an area comprising firing the individual seismic sub-source arrays arranged in two sources:

a first source and a second source placed with an average-distance L between them measured in a direction perpendicular to the towing direction,

said second source is fired after the first source when a certain distanced T in the towing direction has been completed and whereby a first set of data is provided by repeating the shooting, and the method further comprises:

a second seismic survey of the same area for providing a second set of data,

where the individual seismic sub-source arrays are similar to the sub-source arrays used during the former survey,

and a pair of neighboring individual seismic sub-source arrays are arranged to be fired substantially at the same time providing a shot-unit source.

Conducting a marine seismic acquisition survey typically involves a vessel towing at least one seismic streamer through water overlying for instance hydrocarbon-bearing formations. In order to perform a 3-D marine seismic acquisition survey, an array of marine seismic streamers is towed behind the seismic survey vessel. Each streamer may be several thousand meters long.

Each streamer contains a large number of receivers—such as hydrophones and associated electronic equipment—distributed along its length. The vessel also tows one or more seismic sources typically air guns. Acoustic signals, or “shots,” produced by the seismic sources are directed down through the water into the earth beneath, where they are reflected. The reflected signals are received by the receivers, carried in the streamers and transmitted to the seismic survey vessel where the signals are recorded and processed with the ultimate aim of building up a representation of the earth strata in the area being surveyed.

Often two or more sets of seismic data signals are obtained from the same subsurface area. These sets of seismic data signals may be obtained, for instance, by conducting two or more seismic surveys over the same subsurface area but at different times, typically with time lapses between the seismic surveys varying between a few months and a few years. In some cases, the seismic data signals will be acquired to monitor changes in subsurface reservoirs caused by the production of hydrocarbons. The acquisition and processing of time-lapsed, three-dimensional seismic data signals over a particular subsurface area—commonly referred to as“4-D” seismic data—is an important seismic prospecting methodology. When conducting repeated surveys, ideally one wants to repeat all source and receiver positions from the base or previous survey. In practice, this is hard to achieve for the entire survey area due to the different environmental conditions encountered in different surveys.

Further, overlap between shot records is to be avoided, i.e., the firing time between consecutive shots is such that the shot records do not interfere in time with each other. No other shot is fired during a given time window. Therefore, the source sampling is limited on the survey area. A process for improving the source sampling requires significant extra acquisition time. Thus, due to the high cost of marine seismic acquisition, it is common practice to acquire data with a limited density of surface location.

WO2009/138727 discloses a system and a method relating to seismic imaging. It comprises streamers carrying a plurality of receivers towed by a vessel in a towing direction. The citation further comprises a multiple seismic source array comprising a plurality of sub-source arrays, each array includes a series of gun sub-arrays arranged on a cable. The source array is arranged as a dual source array.

However, the method and the system does not improve the acquisition and processing of time-lapsed, three-dimensional seismic data signals over a particular subsurface area.

US2008/0019215 discloses a method and a system for performing a seismic survey in order to inquire seismic data. The survey is using same shot time and positions as used in a baseline survey. Two source groups may be activated simultaneously when appropriate. However, the method does not provide an increased shooting intensity.

The present invention seeks generally to improve a method for conducting a seismic survey such that the abovementioned insufficiencies and drawbacks of today's method for conducting a seismic survey are overcome, or at least it provides a useful alternative. It is desirable to provide a method that increases the shots density and do not increase the acquisition time of the collected seismic data.

According to the invention, a method is provided as per the introductory part of this specification, and wherein the method further comprises

that the individual seismic sub-source arrays are arranged in more than two shot-unit sources,

that each shot-unit source is released after a forgoing release of a shot-unit source has taken place,

and each shot-unit source comprises a pair of neighboring seismic sub-source arrays, both sub-source arrays being different from the pair of seismic sub-source arrays being fired as the following shot-unit source by which a first series of fired shot-unit sources are provided.

The new method upgrades the spatial and temporal 3D sampling of a 4D monitor survey over a producing reservoir, while retaining as a sub-set the sampling conditions of the baseline survey for 4D analysis and providing a higher density survey.

This new higher density survey then becomes a new baseline from which higher resolution 4D attributes can be extracted from subsequent monitor surveys.

The inventive method is based upon the use of sub-source arrays—that is gun-strings—arranged in several shot-unit sources. A shot-unit source is provided by coupling two neighboring sub-source arrays for being fired substantially at the same time. This is done in order to increase the overall density of 3D sampling. The shot positions and 3D grid used for the original baseline survey—which has been carried out with a dual source array arranged in two shooting-sources—is maintained as a subset.

This firing sequence and the pairing of two neighboring sub-source arrays ensure that no gun strings is used on successive shots. When a shot interval—T—in the towing direction is 25 meter for the first survey provided with the dual source array and providing the first set of data, then the shot interval for the opposite and outermost placed shot-unit sources for collecting the second set of data also has to be 25 meter. However, the invention allows an 8.33m shot interval between the fired shot-unit sources, whereby there is time for all guns to refill with air before their next shot.

This technique will almost be able to triple the number of inline shots compared to a conventional dual source baseline and can be used to increase the cross-line spatial sampling. The source array is arranged as a dual source array when the first set of data is obtained. The cross-line spatial sampling is recorded in the X-direction that is perpendicular to the Y-direction/the towing direction. The cross-line spatial sampling may now be increased from 25m to 6.25m when a shooting distance from the center axis of respectively the first source and the second source to zero is 25 meter. (Zero is where the X line crosses the Y line. First source and second source are symmetrically about the Y-axis). The original 25m shot interval making a distance T in the towing direction between the shots, and the 25m crossline sampling of the original baseline survey—whereby the distance between the center axis of the first source and the second source is 50 meter (L)—is now a sub-set of the new high density survey and can be extracted for 4D analysis.

It must be understood that other shot-intervals—mentioned T—can be used, but the shot-interval used when collecting the new set of data for the opposite outermost placed shot-unit sources has to be the same as the shot interval when collecting the first set of data.

In short, when the distance between the first source and the second source in X-direction during sampling of the first set of data is 25*2 meter, and each source comprises 3 sub-source arrays, then the distance between neighboring sub-source arrays during the survey for collecting the second set of data is 12.5 meter. As a consequence of the sub source-arrays are arranged in pairs fired at the same time, the grid obtained by the second set of data has a length of 6.25 meter in the X direction. When the interval between the shootings is 25 meter for the dual source array, then there is time for firing two shot-unit sources between firing the opposite outermost placed shot-unit sources during collecting the second set of data. The firing of the opposite outermost placed shot-unit sources takes place every 25 meters. Consequently the length of the grid in the Y-direction obtained by the second set of data is 6.25 meter. By average-distance L is to understand a distance perpendicular to the Y-direction and measured between a central axis of the first source and a central axis of the second source both central axis parallel to the Y-direction/towing direction.

By the expression outermost placed shot-unit sources/sides is to understand the two sub-source arrays/gun-strings placed in the beginning of a row of individual sub-source arrays making the first shot-unit source, and the two sub-source arrays/gun-strings ending the row making the opposite placed second shot-unit source.

By the expression “similar to the sub-source arrays—” is to understand that the number of sub-source arrays is the same when conducting the two surveys over the area to be surveyed.

According to one embodiment, an outermost placed first shot-unit source is fired and an opposite outermost placed second shot-unit source arranged at the distance L from the other outermost placed first shot-unit source is fired when the distance T is completed,

and at least one shot-unit source is placed in-between said outermost placed shot-units and fired before the opposite outermost placed second shot-unit source is fired.

The distance T is measured in relation to when the outermost placed first shot-unit is fired first time.

According to one embodiment, the first series of fired/released shot-units sources are repeated following same pattern of releasing the shot-units sources as the first series.

According to one embodiment, the number of fired/released shot-unit sources in a series and fired between the two outermost placed shot-unit sources during travelling the distance T is the same, as the number of shot-unit sources fired between the last fired outermost placed shot-unit source and a firing start of a subsequent series.

Thereby making a pattern that is symmetrical and repeated and giving the guns enough time to be loaded.

According to one embodiment, that the individual seismic sub-source arrays arranged in more than two shot-unit sources comprise at least six seismic sub-source arrays arranged substantially parallel to each other and to the towing direction and with the same distance between them,

said the seismic sub-source arrays are numbered consecutive starting with number one at one of the outermost placed sides,

and the seismic sub-source arrays are paired for firing in the following sequence:

firing number 1 and 2, then firing number 3 and 4, then firing number 1 and 2, then firing number 5 and 6, then firing number 2 and 3 and finally firing number 4 and 5, by said sequence a first series of shot-unit sources are provided said sequence is to repeated.

Number 1 and 2 are then providing the first shot-unit source, number 3 and 4 are providing the second shot-unit source, number 5 and 6 are providing the third shot-unit source, number 2 and 3 are providing the fourth shot-unit source, number 4 and 5 are providing the fifth shot-unit source.

According to one embodiment, the first series are repeated, and that the distance in the towing direction between each released shot-unit source is ⅓ of the distance T, and the number of individual sub-source arrays is six.

According to one embodiment, the first seismic survey has been performed by a dual seismic source array comprising

six sub-source arrays arranged substantially parallel in relation to each other in the towing direction, said the seismic sub-source arrays are numbered consecutive starting with number 1 at one of the outermost placed sides, obtaining seismic data for a base line survey and providing a 3D picture of the seabed,

and that a corresponding seismic source array is used after a time period where the individual seismic sub-source arrays are fired in the sequence, where two neighboring seismic sub-source arrays are fired simultaneously thereby providing the shot-unit sources,

firing number 1 and 2, then firing number 3 and 4, then firing number 1 and 2, then firing number 5 and 6, then firing number 2 and 3 and finally firing number 4 and 5,

by said sequence the first series of fired shot-units sources are provided and which are to be repeated, whereby a duplicate of the fired dual seismic source is obtained for the first shot-unit sources and the fourth shot-unit source.

According to one embodiment, the distance between the individual sub-source arrays is L/4, and that the new set of data provides a grid having a size of L/8*T/3.

According to one embodiment, the first series is repeated, whereby the shot-unit sources are released in the same order as the first series, whereby a duplicate of a position of the dual seismic source is provided for shots provided by shot-unit sources having the number 1, 4, 7 - - - that is number 1+n*3 where n is a consecutive integer.

According to one embodiment, the first source comprises three sub-source arrays, and the second source comprises three sub-source arrays.

According to one embodiment, the number of sub-source arrays used for collecting the second set of data is the same as the number of sub-source arrays used for collecting the first set of data.

According to one embodiment, a data-grid for providing the second set of data for analyzing the seabed is obtained,

According to one embodiment the data-grid is preferably in the size of 6.25m*6.25 m.

According to one embodiment, the seismic data obtained are processed in a process-unit such as a data processor, whereby the data are analyzed in connection with former baseline survey.

According to one embodiment, each seismic sub-source array comprises a cluster of guns spaced along a longitudinal means such as a wire or a cable, said each gun on a seismic sub-source array is activated independent of the other guns on the same seismic sub-source array,

and that a fired gun is reloaded in the time interval between firing of said gun has taken place and firing of other guns, whereby said gun is ready to be fired again.

The benefits of the invention when using the shot-interval 25 m and using 6 sub-source arrays are:
A high density monitor survey sampled on 6.25m×6.25m 3D grid which has potential to provide significant uplift in reservoir imaging which secondly can result in enhanced recovery of hydrocarbons using enhanced engineering techniques.
The historical baseline and monitor surveys are sub-sets of the new high definition 3D survey obtained by the new set of data, which will allow 4D analysis at the resolution of previous 3D surveys and higher 4D resolution for future monitor surveys.
The significant increase in inline and crossline shot density along a baseline 3D shot line will allow higher probability of increased source to receiver repeatability. This is due to that, a 4D baseline seldom is 100% perfect since both source and receivers (streamer cables) quite often are out of position. Erratic vessel steering and/or currents changing lateral position of the streamers may cause this. When shooting a repeat survey it is therefore very difficult to replicate previous source and receiver position 100% correct. When increasing the shot density there will be an increase probability of matching source/receiver positions. By inline shot is to understand shot in the towing direction, and crossline shot is shot in the direction perpendicular to the towing direction.
The high definition 6.25m×6.25m grid will allow enhanced monitoring of changes in overburden delay times as a function of compaction.
The high definition 6.25m×6.25m grid will allow enhanced monitoring of spatial distribution and movement of fluids.

### BRIEF DESCRIPTION OF THE DRAWINGS

FIG. 1 is a view of a known dual source system arranged to be fired alternately between first source and second source.

FIG. 2 is a view of the same system but arranged to be fired as a five shot-unit sources.

The invention will be explained with reference to the figures.

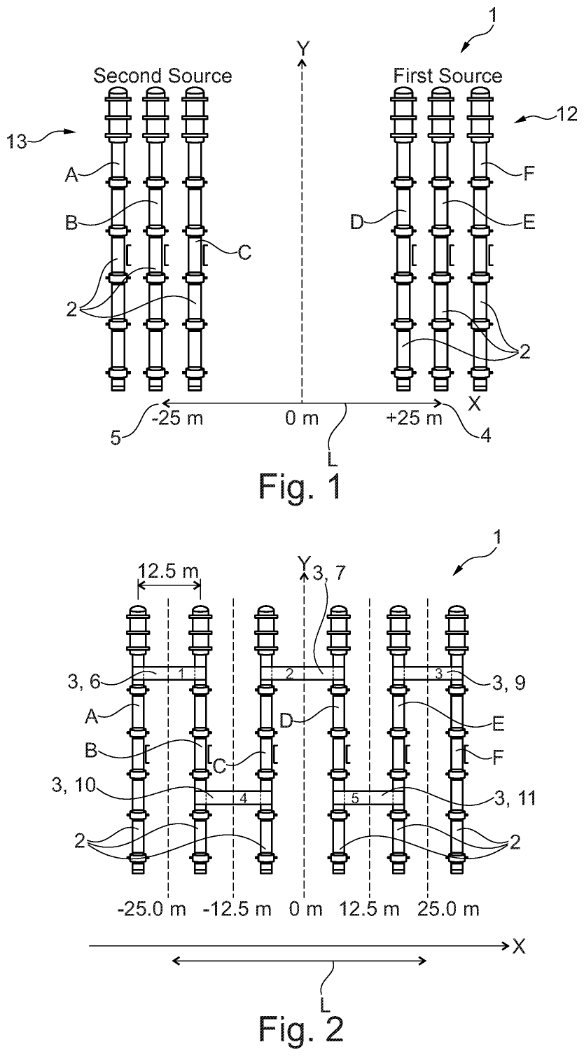

FIG. 1 shows a seismic source array 1 arranged as a dual source comprising a first source 12 and a second source 13. Each source 12, 13 comprises three parallel arranged sub-source arrays 2—gun-strings—comprising a cluster of guns spaced along a cable. The sources 12,13 are arranged symmetrical around a towing direction shown with arrow Y. First source 12 comprises gun-string number 4 denoted D, gun-string number 5 denoted E and gun-string number 6 denoted F; second source comprises gun-string number 1 denoted A, gun-string number 2 denoted B and gun-string number 3 denoted C.

The towing direction of the seismic source array is the Y direction and the line perpendicular to the towing direction is the X-direction. The crossing between X line and Y line is starting point (0, 0). The mean-distance L between the first source 12 and the second source 13 in the X-direction is determined as the distance between the central axis of the first source 12 and the central axis of the second source. In the example the distance from zero to the first source 12 is 25 m and marked with the number 4 being the center axis of the first source and the distance from zero to the second source 13 is −25 m and marked with the number 5 being the center axis of second source. Further, the shooting interval T in the towing direction is chosen to be 25 meter.

The first survey of a seabed area is provided with the dual source shown in FIG. 1.

The result is as follows as shooting takes place with the interval of 25 meter in the Y direction and in X direction alternating between first source and second source:

TABLE 1
Dual Source at 25 m SPI (interval in Y-direction between shooting)

| Shot | X | Y |
|---|---|---|
| 1 | −25 | 0 |
| 2 | 25 | 25 |
| 3 | −25 | 50 |
| 4 | 25 | 75 |
| 5 | −25 | 100 |
| 6 | 25 | 125 |
| 7 | −25 | 150 |
| 8 | 25 | 175 |
| 9 | −25 | 200 |
| 10 | 25 | 225 |
| 11 | −25 | 250 |
| 12 | 25 | 275 |
| 13 | −25 | 300 |
| 14 | 25 | 325 |
| 15 | −25 | 350 |
| 16 | 25 | 375 |

A similar or the same seismic source array 1 is used for providing a new set of data for the same area. This may be done month or years after.

However, the sub-source arrays 2 are arranged and fired in another way.

The gun strings 2 are paired and fired two and two in such a way that paired neighboring gun strings 2 are fired substantially at the same time thereby making a more intensive shooting and each paired gun-string 2 provides a shot-unit source 3.

The distance between neighboring gun-strings 2 is the same in the X-direction and is L/4 which in this case is 12.5 meter. The new set of data provided by using the seismic source array 1 shown in FIG. 2 will then cause that the grid-size in X direction is 12.5/2 meter, that is 6.25 meter.

The shot-unit sources 3 are provided as follows:

number A and B are providing the first shot-unit source 6; number C and D are providing the second shot-unit source 7; number E and F are providing the third shot-unit source 9; number B and C are providing the fourth shot-unit source 10 and D and E is providing the fifth shot-unit source 11.

This sequence provides a series that are repeated. The first shot-unit source 3 is used twice in a series.

The paired gun strings A,B and E,F are at the outermost sides. In the X direction they are placed such that the middle line between two paired gun strings 2 is placed with the same X-coordinate as is the case with the central axis of first source and of second source during the sampling of the first dataset (In this case +25 m and −25 meter.)

Source 1, 2, 3, 4, 5 in table 2 refer to the sequence of firing the paired sub-source arrays 2, and in FIG. 2 shown with the same numbers placed in a band connecting neighboring sub-source arrays/gun-strings 2.

The sequence takes place as follows:

TABLE 2
Penta Source at 8.3 m SPI

| Shot-unit | | | | |
|---|---|---|---|---|
| Source # | Shot | X | Y | Gun Strings |
| 1 | 1 | −25 | 0.0 | 1 + 2 |
| 2 | 2 | 0 | 8.3 | 3 + 4 |
| 1 | 3 | −25 | 16.7 | 1 + 2 |
| 3 | 4 | 25 | 25.0 | 5 + 6 |
| 4 | 5 | −12.5 | 33.3 | 2 + 3 |
| 5 | 6 | 12.5 | 41.7 | 4 + 5 |
| 1 | 7 | −25 | 50.0 | 1 + 2 |
| 2 | 8 | 0 | 58.3 | 3 + 4 |
| 1 | 9 | −25 | 66.6 | 1 + 2 |
| 3 | 10 | 25 | 75.0 | 5 + 6 |
| 4 | 11 | −12.5 | 83.3 | 2 + 3 |
| 5 | 12 | 12.5 | 91.6 | 4 + 5 |
| 1 | 13 | −25 | 100.0 | 1 + 2 |
| 2 | 14 | 0 | 108.3 | 3 + 4 |
| 1 | 15 | −25 | 116.6 | 1 + 2 |
| 3 | 16 | 25 | 125.0 | 5 + 6 |
| 4 | 17 | −12.5 | 133.3 | 2 + 3 |
| 5 | 18 | 12.5 | 141.6 | 4 + 5 |
| 1 | 19 | −25 | 150 | 1 + 2 |
| 2 | 20 | 0 | 158.3 | 3 + 4 |
| 1 | 21 | −25 | 166.6 | 1 + 2 |
| 3 | 22 | 25 | 175 | 5 + 6 |
| 4 | 23 | −12.5 | 183.3 | 2 + 3 |
| 5 | 24 | 12.5 | 191.6 | 4 + 5 |
| 1 | 25 | −25 | 200 | 1 + 2 |
| 2 | 26 | 0 | 208.3 | 3 + 4 |
| 1 | 27 | −25 | 216.6 | 1 + 2 |
| 3 | 28 | 25 | 225 | 5 + 6 |

The line is a marking end of a series and the beginning of a new.

The shooting interval in the Y-direction is now T/3 that is 25/3 meter. The table shows a shooting sequence that allows 8.33 m inline shot interval—that is in Y-direction—for the five designated shot-unit sources 3 where every third shot repeats a shot position of the dual source baseline shots shown in table 1.

Thereby the additional sub-source arrays increase the overall density of 3D sampling while maintaining as a subset the shot positions and 3D grid used for the original baseline survey.

The example shown in table 1 and table 2 is shown using six gun-strings/sub-source arrays 2. However, the number of gun strings 2 could be more or less if convenient. The number of gun strings used for providing the second set of data just has to be the same as is the case when providing the first set of data.

1-15. (canceled)

16. A method for conducting a seismic survey for collecting seismic data off shore comprising:
towing a seismic source array comprising individual seismic sub-source arrays,
towing the seismic source array behind a marine vessel in a towing direction generating desired acoustic signals by activating the seismic source array by releasing acoustic shots means,
and said acoustics signals are reflected when hitting a seabed, said reflected signals are picked up by streamer cables each carrying a plurality of receivers, and said reflected acoustic signals are transferred into seismic pictures,
the method comprises a first seismic survey of an area comprising firing the individual seismic sub-source arrays arranged in two sources:
a first source and a second source placed with an average-distance L between them measured in a direction perpendicular to the towing direction, said second source is fired after the first source when a certain distanced T in the towing direction has been completed, and whereby a first set of data is provided by repeating the shooting,
the method further comprises a second seismic survey of the same area for providing a second set of data, where the individual seismic sub-source arrays are similar to the sub-source arrays used during the former survey,
and a pair of neighboring individual seismic sub-source arrays are arranged to be fired substantially at the same time providing a shot-unit source wherein the individual seismic sub-source arrays are arranged in more than two shot-unit sources,
that each shot-unit source is released after a forgoing release of a shot-unit source has taken place, and
each shot-unit source comprises a pair of neighboring seismic sub-source arrays, both sub-source arrays being different from the pair of seismic sub-source arrays being fired as the following shot-unit source by which a first series of fired shot-unit sources are provided.

17. The method according to claim 16, wherein an outermost placed first shot-unit source is fired, and an opposite outermost placed second shot-unit source arranged at the distance L from the other outermost placed first shot-unit source is fired when the distance T is completed, and that at least one shot-unit source is placed in-between said outermost placed shot-units and fired before the opposite outermost placed second shot-unit source is fired.

18. The method according to claim 16, wherein the first series of fired/released shot-units sources are repeated following same pattern of releasing the shot-units sources as the first series.

19. The method according to claim 16, wherein the number of fired/released shot-unit sources in a series and fired between the two outermost placed shot-unit sources during travelling the distance T is the same, as the number of shot-unit sources fired between the last fired outermost placed shot-unit source in a series and a firing start of a subsequent series.

20. The method according to claim 16, wherein the individual seismic sub-source arrays arranged in more than two shot-unit sources comprise at least six seismic sub-source arrays arranged substantially parallel to each other and to the towing direction and with the same distance between them, said the seismic sub-source arrays are numbered consecutive starting with number one at one of the outermost placed sides, and the seismic sub-source arrays are paired for firing in the following sequence: firing number 1 and 2, then firing number 3 and 4, then firing number 1 and 2, then firing number 5 and 6, then firing number 2 and 3 and finally firing number 4 and 5, by said sequence a first series of shot-unit sources 3 are provided said sequence is to repeated.

21. The method according to claim 16, wherein the first series are repeated, and that the distance in the towing direction between each released shot-unit source is ⅓ of the distance T, and the number of individual sub-source arrays is six.

22. The method according to claim 16, wherein the first seismic survey has been performed by a dual seismic source array comprising six sub-source arrays arranged substantially parallel in relation to each other in the towing direction, said the seismic sub-source arrays are numbered consecutive starting with number 1 at one of the outermost placed sides, obtaining seismic data for a base line survey and providing a 3D picture of the seabed, and that a corresponding seismic source array is used after a time period where the individual seismic sub-source arrays are fired in the sequence, where two neighboring seismic sub-source arrays are fired simultaneously thereby providing the shot-unit sources, firing number 1 and 2, then firing number 3 and 4, then firing number 1 and 2, then firing number 5 and, then firing number 2 and 3 and finally firing number 4 and 5, by said sequence the first series of fired shot-units sources are provided and which are to be repeated, whereby a duplicate of the fired dual seismic source is obtained for the first shot-unit sources and the fourth shot-unit source.

23. The method according to claim 16, wherein the distance between the individual sub-source arrays is L/4, and that the new set of data provides a grid having a size of L/8*T/3.

24. The method according to claim 16, wherein the first series is repeated, whereby the shot-unit sources are released in the same order as the first series, whereby a duplicate of a position of the dual seismic source is provided for shots provided by shot-unit sources having the number 1, 4, 7 - - - that is number 1+n*3 where n is a consecutive integer.

25. The method according to claim 16, wherein the number of sub-source arrays used for collecting the second set of data is the same as the number of sub-source arrays used for collecting the first set of data.

26. The method according to claim 16, wherein the first source comprises three sub-source arrays, and the second source comprises three sub-source arrays.

27. The method according to claim 16, wherein the seismic data obtained are processed in a process-unit such as a data processor, whereby the data are analyzed in connection with a former baseline survey.

28. The method according to claim 16, wherein each seismic sub-source array comprises a cluster of guns spaced along a longitudinal means such as a wire or a cable, said each gun on a seismic sub-source array is activated independent of the other guns on the same seismic sub-source array, and that a fired gun is reloaded in the time interval between firing of said gun has taken place and firing of other guns, whereby said gun is ready to be fired again.

29. The method according to claim 16, wherein a data-grid for providing the second set of data for analyzing the seabed is obtained.

30. The method according to claim 16, wherein the data-grid is in the size of 6.25m*6.25 m.
